(19) United States
(12) Patent Application Publication
(10) Pub. No.: US 2016/0245222 A1
(43) Pub. Date: Aug. 25, 2016

(54) PISTON WITH A PISTON RING GROOVE, IN PARTICULAR A COMPRESSION GROOVE

(71) Applicant: MAHLE INTERNATIONAL GMBH, Stutgart (DE)

(72) Inventor: Wolfgang Issler, Schwaikheim (DE)

(21) Appl. No.: 15/023,978

(22) PCT Filed: Sep. 18, 2014
(86) PCT No.: PCT/EP2014/069922

§ 371 Date: Mar. 22, 2016

(30) Foreign Application Priority Data
Sep. 23, 2013 (DE) 10 2013 219 052.2

(51) Int. Cl. F02F 3/00; F16J 9/12

(52) U.S. Cl. CPC F02F 3/00; F16J 9/12

(57) ABSTRACT

A piston for an internal combustion engine may have a piston ring groove arranged on an outer circumference of the piston. The piston ring groove may include a lower groove flank and an upper groove flank spaced apart from one another in an axial direction of the piston, and a groove base extending between the groove flanks. The groove base may transition into the lower groove flank with a radius of curvature that is larger than a radius of curvature with which the groove base transitions into the upper groove flank.

### CROSS-REFERENCE TO RELATED APPLICATIONS

This application claims priority to German Patent Application No. 10 2013 219 052.2, filed Sep. 23, 2013, and International Patent Application No. PCT/EP2014/069922, filed Sep. 18, 2014, both of which are hereby incorporated by reference in their entirety.

### TECHNICAL FIELD

The invention relates to piston ring grooves, in particular to compression grooves, on the outer circumference of a piston for internal combustion engines.

### BACKGROUND

In accordance with the increasing power density of modern, often supercharged internal combustion engines, the pistons are subject to very high and intensely fluctuating temperature and pressure loads. The same applies to the piston rings, which must firstly ensure an adequate heat flow from the piston to the respective (cooled) cylinder and must secondly ensure a good sealing of the gap between the piston circumference and the cylinder. The so-called compression rings, which are arranged close to the piston crown and accordingly close to the combustion chamber of the engine, are subject to particularly intense loads. The contact pressure of the compression rings against the cylinder wall is generated only to a relatively small extent by elastic bracing of the piston ring; the compression rings are pressed against the cylinder wall primarily by the gas pressure prevailing in the combustion chamber. Said gas pressure has the effect firstly that, within the ring groove on the piston circumference in which the compression ring is received, said compression ring is forced axially against the lower groove flank (remote from the piston crown), and secondly, the gas pressure acting in the ring groove acts on the inner circumference of the piston ring, such that said piston ring bears with correspondingly high pressure by way of its outer circumference against the cylinder wall.

In general, the pistons of internal combustion engines have two compression rings, wherein the second compression ring, which is further remote from the piston crown, is intended in particular to prevent or minimize a so-called blow-by of the combustion gases in the direction of the crankcase of the engine.

The encircling ring grooves on the piston which serve for receiving the piston rings constitute inevitable notches on the outer circumference of the piston body, and thus an inevitable structural weakening of the piston body. Therefore, it is necessary to seek a shape of the ring grooves which is optimized with regard to the structural strength of the piston. Here, however, there is only limited design freedom because the shape of the ring grooves also has repercussions on the function of the piston rings, which, in accordance with the statements above, are pressed against the cylinder wall primarily by the gas pressure prevailing in the piston working chamber. Here, for the sealing action of the respective piston ring, a transmission of pressure to the inner circumference of the piston ring with as far as possible no delay is important.

### SUMMARY

It is now an object of the invention to provide, for a ring groove of a piston, an optimum shape with which good structural strength of the piston is ensured and adequate design freedom for the optimization of the transmission of the gas pressure to the piston ring is provided.

For this purpose, it is provided according to the invention that the groove base of at least one piston ring groove, preferably of the uppermost piston ring groove which is closest to the piston crown, transitions with a relatively large radius of curvature into the lower flank (remote from the piston crown) and with a relatively small radius of curvature into the upper flank (at the piston crown side) of the ring groove.

The invention is based on the general concept whereby, in the case of one or more piston ring grooves, preferably at least in the case of the most highly loaded piston ring groove, which serves for receiving the first compression ring, the different dynamic loads on the groove flanks are taken into consideration in the shaping of the ring groove. The lower groove flank, which is subjected to particularly intense load during the expansion strake by the gas pressure or by the piston ring which is acted on by the gas pressure, transitions into the groove base with a relatively large radius of curvature, such that crack formation at the transition is prevented. By contrast, in the case of the considerably less highly loaded, upper groove flank, a small radius of curvature at the transition to the groove base is readily possible.

In a particularly preferred embodiment of the invention, it is provided that the region with the large radius of curvature extends across a central plane of the ring groove, which central plane runs centrally between the groove flanks and radially with respect to the piston axis. Thus, it is made advantageously possible for the groove base to have, between the region of large radius of curvature and the region of small radius of curvature, a conical region which is inclined with respect to the piston axis and which widens in the direction of the upper groove flank.

In a preferred embodiment, the upper and lower groove flanks are horizontally running planes, that is to say planes running at right angles to the piston axis, wherein the region which adjoins the lower groove flank and which has the large radius of curvature extends over an angle of greater than 90°, that is to say beyond an orientation parallel to the piston axis. The region with the small radius of curvature preferably extends, adjoining the upper groove flank, over an angle of less than 90°, wherein, between the two rounded regions, there is advantageously situated a conical section which widens in the direction of the piston crown, such that the groove depth decreases toward the piston crown. In this way, the roundings can adjoin the upper and lower groove flanks in each case preferably approximately at the same groove depth, such as is required by the piston ring, in relation to the piston circumference, wherein the conical surface on the groove base has the effect of entirely or partially compensating for the different radii of curvature. This design makes it possible to realize a small dead volume behind the piston ring, and thus a low discharge of unburned hydrocarbons, without the piston ring being pushed into one of the two roundings on the groove base.

The groove flanks, the radii and the groove base preferably each transition into one another in kink-free fashion, whereby the generation of stress peaks is prevented.

This shaping of the ring groove offers the advantage that only a relatively small free space remains between groove base and piston ring radially within the inner circumference of the piston ring. This promotes a delay-free exertion of pressure on the inner circumference of the piston ring by the gas pressure. Furthermore, the dead volume behind the ring, in which unburned mixture residues can collect, is reduced. In this way, the undesired emission of hydrocarbons is reduced.

With regard to dimensioning, it is preferably provided, in the case of the relatively large radius of curvature, that the dimension thereof is firstly greater than one quarter of the dimension of the groove width and secondly less than one third of the dimension of the groove width.

Otherwise, with regard to preferred features of the invention, reference is made to the claims and the following discussion of the drawing, on the basis of which a particularly preferred embodiment of the invention is described in more detail.

It is self-evident that the illustrated features may be essential to the invention not only in the respectively illustrated combination with other features but also individually.

### BRIEF DESCRIPTION OF THE DRAWINGS

In the drawings:

FIG. 1 shows a detail axial section of a piston close to its piston crown and of the associated cylinder of an internal combustion engine,

FIG. 2 is an enlarged illustration of the detail II in FIG. 1.

### DETAILED DESCRIPTION

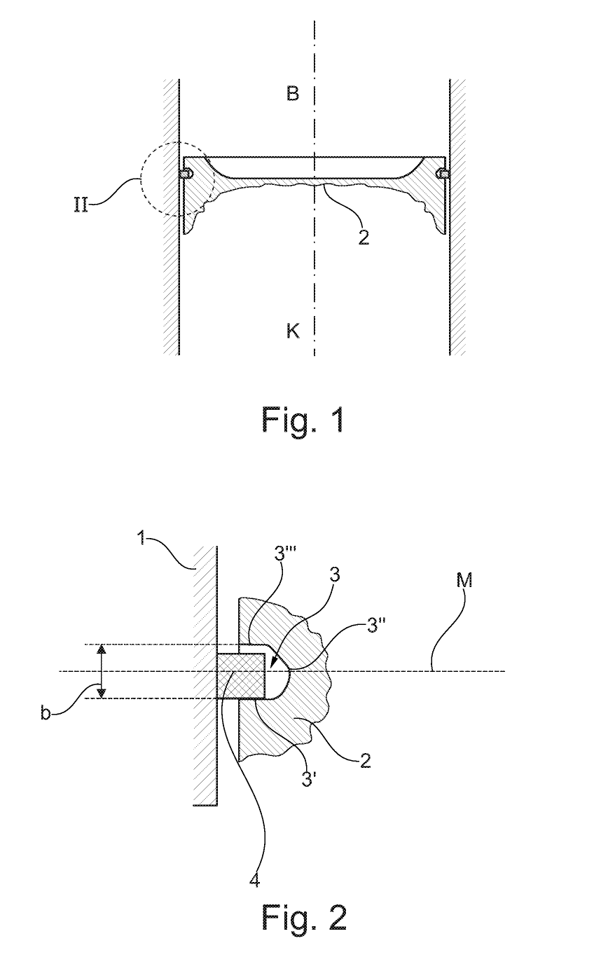

In FIG. 1, a piston 2 is arranged in displaceable fashion in a cylinder 1 of an internal combustion engine, of which piston substantially only the region of the piston crown is illustrated, by way of which the piston 1, within the cylinder, separates a combustion chamber region B from the crankcase region K. To seal off the combustion chamber region B with respect to the crankcase region K, there is arranged on the piston circumference or skirt at least one ring groove 3 which receives a piston ring 4, wherein, in FIG. 1, only the uppermost ring groove 3, for the so-called compression ring 4, is illustrated. In general, pistons of internal combustion engines have two compression rings and an oil stripper ring which is spaced apart further from the piston crown.

As can be seen in particular from FIG. 2, the compression ring 4 has an axial and radial clearance within the associated ring groove 3. During the operation of the internal combustion engine, the piston ring is forced axially against the lower groove flank in the figures by the gas pressure in the combustion chamber B. Furthermore, the gas pressure acts on the inner circumference of the piston ring 4, with the result that it bears with correspondingly intensified contact pressure against the cylinder wall.

As can be seen in particular in FIG. 2, the lower groove flank 3′ (remote from the piston crown) in the drawing transitions with a relatively large radius of curvature into the groove base 3″. By contrast, the transition between the groove base 3″ and the upper groove flank 3′″ (at the piston crown side) has a relatively small radius of curvature. The region with the large radius of curvature extends across a radial central plane M of the piston 1, which radial central plane runs centrally between the groove flanks 3′ and 3′″. Adjoining the transition region of large radius of curvature, the groove base 3″ has a conical region which widens in the upward direction, that is to say toward the combustion chamber B, which conical region then transitions, with a small radius of curvature, into the upper groove flank 3′″.

By means of said conical region, the volume of the free space remaining between the inner circumference of the piston ring 4 and the groove base 3″ is reduced in a desired manner. This offers the advantage that the gas pressure of the combustion chamber B is transmitted substantially without delay to the inner circumference of the piston ring 4.

The radius of curvature of the transition between the lower groove flank 3′ and the groove base 3″ preferably has a dimension which lies between 0.4 b and 0.6 b, wherein b denotes the spacing of the groove flanks 3′ and 3′″ from one another.

1. A piston for an internal combustion engine, comprising:
a piston ring groove arranged on an outer circumference of the piston, the piston ring groove having a lower groove flank and an upper groove flank spaced apart from one another in an axial direction of the piston and a groove base extending between the groove flanks,
wherein the groove base transitions into the lower groove flank with a radius of curvature that is larger than a radius of curvature with which the groove base transitions into the upper groove flank.

2. The piston as claimed in claim 1, wherein a region with the radius of curvature of the lower groove flank extends across a central plane of the ring groove, the central plane running centrally between the groove flanks and radially with respect to a piston axis.

3. The piston as claimed in claim 1, wherein the groove base has, between regions of the radii of curvatures of the groove flanks, a conical region that is inclined with respect to a piston axis and which widens in a direction toward the upper groove flank.

4. The piston as claimed in claim 1, wherein the radius of curvature of the lower groove has a dimension greater than one third of a spacing between the groove flanks.

5. The piston as claimed in claim 4, wherein the radius of curvature of the lower groove has a dimension between 40% and 60% of the spacing between the groove flanks.

6. The piston as claimed in claim 2, wherein the groove base has, between regions of the radii of curvatures of the groove flanks, a conical region that is inclined with respect to a piston axis and which widens in a direction toward the upper groove flank.

7. The piston as claimed in claim 2, wherein the radius of curvature of the lower groove has a dimension greater than one third of a spacing between the groove flanks.

8. The piston as claimed in claim 7, wherein the radius of curvature of the lower groove has a dimension between 40% and 60% of the spacing between the groove flanks.

9. The piston as claimed in claim 3, wherein the radius of curvature of the lower groove has a dimension greater than one third of a spacing between the groove flanks.

10. The piston as claimed in claim 9, wherein the radius of curvature of the lower groove has a dimension between 40% and 60% of the spacing between the groove flanks.

11. The piston as claimed in claim 1, wherein the groove flanks are planes running perpendicularly to an axis of the piston.

12. The piston as claimed in claim 1, wherein the radius of curvature of the lower groove flank extends over an angle of greater than 90°, and the radius of curvature of the upper groove flank extends over an angle of less than 90°.

13. A piston for an internal combustion engine, comprising:
at least one ring groove extending circumferentially around the piston, the at least one ring groove having a lower groove flanks and an upper groove flank spaced apart from one another in an axial direction of the piston and a groove base extending between the groove flanks, the groove flanks being planes running perpendicularly to an axis of the piston,
at least one compression ring in the at least one ring groove, the at least one compression ring having an axial clearance and a radial clearance within the at least one ring groove,
wherein the groove base transitions into the lower groove flank with a radius of curvature extending over an angle of greater than 90°, and into the upper groove flank with a radius of curvature extending over an angle of less than 90°.

14. The piston as claimed in claim 13, wherein a region with the radius of curvature of the lower groove flank extends across a central plane of the ring groove, the central plane running centrally between the groove flanks and radially with respect to the axis of the piston.

15. The piston as claimed in claim 13, wherein the groove base has, between regions of the radii of curvature of the groove flanks, a conical region that is inclined with respect to the axis of the piston and which widens in a direction toward the upper groove flank.

16. The piston as claimed in claim 13, wherein the radius of curvature of the lower groove has a dimension greater than one third of a spacing between the groove flanks.

17. The piston as claimed in claim 16, wherein the radius of curvature of the lower groove has a dimension between 40% and 60% of the spacing between the groove flanks.

18. The piston as claimed in claim 14, wherein the groove base has, between regions of the radius of curvatures of the groove flanks, a conical region that is inclined with respect to a piston axis and which widens in a direction toward the upper groove flank.

19. The piston as claimed in claim 14, wherein the radius of curvature of the lower groove has a dimension greater than one third of a spacing between the groove flanks.

20. The piston as claimed in claim 19, wherein the radius of curvature of the lower groove has a dimension between 40% and 60% of the spacing between the groove flanks.
